(19) United States
(12) Patent Application Publication
(10) Pub. No.: US 2012/0314287 A1
(43) Pub. Date: Dec. 13, 2012

(54) LUMINANCE ENHANCEMENT FILM AND BACKLIGHT UNIT COMPRISING THE SAME

(75) Inventors: Jeong Yeol Moon, Yongin-si (KR); A Reum Han, Seoul (KR); Kyung Nam Kim, Yongin-si (KR); Deug Soo Ryu, Yongin-si (KR); Dae Shik Kim, Yongin-si (KR)

(73) Assignee: KOLON INDUSTRIES, INC., Gwacheon-si, Gyeonggi-do (KR)

(21) Appl. No.: 13/520,066

(22) PCT Filed: Dec. 29, 2011
(86) PCT No.: PCT/KR2011/010299

§ 371 Date: Aug. 22, 2012

(30) Foreign Application Priority Data
Dec. 31, 2010 (KR) 10-2010-0140822
Dec. 31, 2010 (KR) 10-2010-0140833
Dec. 27, 2011 (KR) 10-2011-0143805
Dec. 27, 2011 (KR) 10-2011-0143836
Dec. 29, 2011 (KR) 10-2011-0145439

(51) Int. Cl. G02B 5/02; G02B 5/30

(52) U.S. Cl. 359/489.11; 359/599

(57) ABSTRACT

The present invention relates to a luminance-enhanced film used for displays. The present invention provides a luminance enhancement film including a multilayer thin film, which can ensure the reliability to external environmental changes, such as temperature change and the like, and a backlight unit including the luminance enhancement film.

### TECHNICAL FIELD

The present invention relates to a luminance enhancement film used in displays.

### BACKGROUND ART

Generally, a liquid crystal display (LCD), which is a flat panel display for displaying an image using liquid crystals, is advantageous in that it is thin and light and has a low driving voltage and low power consumption. Therefore, liquid crystal displays are widely used in various industrial fields.

A liquid crystal display includes a liquid crystal panel including a thin film transistor (TFT) substrate, a color filter substrate facing the TFT substrate, and a liquid crystal layer disposed between both of the substrates to change the light transmission. Further, a liquid crystal display needs a backlight unit for supplying light to a liquid crystal panel because the liquid crystal panel is a non-luminescent device that cannot emit light by itself.

The backlight unit includes one or more kinds of optical films applied on a light guide plate or a light diffusion plate in order to improve the luminance of output light and improve the viewing angle of output light.

The optical films may be classified into luminance enhancement films and light diffusion films. Recently, as liquid crystal displays have become slim, it has been necessary to combine these films.

For the combination thereof, a luminance enhancement film (for example, a reflective polarizing film) and a light diffusion film were laminated (refer to Korean Unexamined Patent Publication No. 10-2006-055341).

However, although films having different functions are simply attached, it is difficult to prevent the luminance of a liquid crystal display from deteriorating when the liquid crystal display is used for a long period of time.

### DISCLOSURE

### Technical Problem

Accordingly, the present invention has been made to solve the above-mentioned problems, and an object of the present invention is to provide a luminance enhancement film which can ensure the reliability to external environmental changes, and a backlight unit including the luminance enhancement film.

### Technical Solution

In order to accomplish the above object, a first aspect of the present invention provides a luminance enhancement film including a multilayer thin film. The luminance enhancement film improves luminance, has high reliability to external environmental changes (for example, temperature, humidity, etc.). When it is used in the liquid crystal display, it can improve the reliability to external environmental changes, color reproducibility and life cycle characteristics of a liquid crystal display.

The luminance enhancement film according to the first aspect of the present invention includes a multilayer thin film including a first thin film and a second thin film disposed near the first thin film, wherein the luminance reduction rate measured after subjecting the luminance enhancement film to the following first environmental condition and the luminance reduction rate measured after subjecting the luminance enhancement film to the following second environmental condition are 10% or less, respectively. Here, the first environmental condition is the condition that the luminance enhancement film is left in a chamber at 50° C. for 1000 hours, and the second environmental condition is the condition that the luminance enhancement film is left in a chamber at −20° C. for 1000 hours.

Further, the luminance enhancement film according to the first aspect of the present invention includes orthogonally-intersecting first and second axes in the plane thereof. The luminance enhancement film can reflect the incident light polarized along the first axis, and can transmit the incident light polarized along the second axis.

A second aspect of the present invention provides a backlight unit including the luminance enhancement film.

### DESCRIPTION OF DRAWINGS

The above and other objects, features and other advantages of the present invention will be more clearly understood from the following detailed description taken in conjunction with the accompanying drawing, in which:

FIG. 1 is a schematic sectional view showing a luminance enhancement film according to the present invention.

### REFERENCE NUMERALS

1: light diffusion film

2: adhesive layer

3: multilayer thin film

4: adhesive layer

5: light diffusion film

### BEST MODE

A luminance enhancement film can be used to improve the luminance of a backlight unit which is provided as an external light source of a liquid crystal display which has no self-emitting light source. As there are various forms, uses and the like of the liquid crystal display, it has become necessary to make more improvements to the characteristics of a luminance enhancement film used in the liquid crystal display. For example, in order to ensure the reliability of a liquid crystal display to external environmental changes, it is necessary to minimize the luminance reduction rate of a luminance enhancement film such that the luminance characteristics of the luminance enhancement film can persist even when external environmental changes occur.

Thus, the luminance enhancement film including a multilayer thin film according to an embodiment of the present invention is configured such that the luminance reduction rate thereof measured after being subjected to the following first environmental condition and the luminance reduction rate thereof measured after being subjected to the following second environmental condition are 10% or less, respectively. Here, the first environmental condition is the condition that the luminance enhancement film is left for 1000 hours in a chamber having a temperature of 50° C., and the second environmental condition is the condition that the luminance enhancement film is left for 1000 hours in a chamber having a temperature of −20° C. The luminance reduction rate under each of the environmental conditions is defined as a ratio of the luminance measured under each of the environmental conditions to the luminance measured under general environmental conditions, that is, under the environmental conditions of a temperature of 25° C. and a relative humidity (RH) of 50%. The luminance reduction rate means the rate of change of the luminance of the luminance enhancement film, and the method of measuring the luminance reduction will be described in detail later.

The luminance reduction rate thereof measured after being subjected to the first environmental condition and the luminance reduction rate thereof measured after being subjected to the second environmental condition may be 10% or less, preferably 8% or less, and more preferably 5% or less, respectively. As the luminance reduction rate decreases, a backlight unit employing the luminance enhancement film is able to have high reliability to external environmental changes, such as temperature and the like.

The luminance enhancement film may be configured such that the luminance reduction rate thereof measured after being subjected to the following third environmental condition, which is more extreme than the first and second environmental conditions, and the luminance reduction rate thereof measured after being subjected to the following fourth environmental condition are 10% or less, respectively. Here, the third environmental condition is the condition that the luminance enhancement film is left for 1000 hours in a chamber having a temperature of 60° C. and a relative humidity (RH) of 95%, and the fourth environmental condition is the condition that the luminance enhancement film is left for 60 minutes in a chamber having a temperature of 70° C. and is then left for 60 minutes in a chamber having a temperature of −20° C., which are repeated 100 times. As such, the luminance enhancement film satisfying the environmental conditions can guarantee higher reliability.

A luminance enhancement film according to an embodiment of the present invention includes a multilayer thin film including at least one first thin film and at least one second thin film. The luminance enhancement film includes a light diffusion layer on at least one side of the multilayer thin film. Here, the light diffusion layer may be a coating layer formed by applying a light diffusion composition or may be a light diffusion film consisting of a base film and a light diffusion layer. Specifically, a light diffusion film may be a polycarbonate (PC) film having a light diffusion function or a film including a light diffusion layer.

Further, the stretched multilayer film may be provided on one side thereof with a film including a light diffusion layer and may be provided on the other side thereof with an anti-blocking layer having relatively low turbidity. That is, the stretched multilayer film is configured such that slip properties are provided between the multilayer film and an optical member located beneath the multilayer film. It is preferred that the turbidity of the anti-blocking layer be 1˜30%. In the case where the turbidity of the anti-blocking layer is more than 30%, when the light, having passed through the optical member, enters the luminance enhancement film, the incident light is generally scattered from the surface of the luminance enhancement film rather than penetrates into the surface thereof, thus deteriorating the luminance of the luminance enhancement film. Therefore, it is preferred that the turbidity of the anti-blocking layer be adjusted.

In the case where the light diffusion layer is directly applied onto the stretched multilayer thin film, the light diffusion layer may be formed by applying and drying a light diffusion composition using a general method. Even in this case, the stretched multilayer thin film may be provided on one side thereof with the light diffusion layer, and may be provided on the other side thereof with the anti-blocking layer having a turbidity of 1˜30% in order to provide slip properties between the multilayer thin film and the optical member located on the bottom of it.

If the light diffusion layer is formed in the form of a light diffusion film, in order to attach the multilayer thin film to the light diffusion film, the multilayer thin film may be attached to the light diffusion film after applying an adhesive layer onto the multilayer thin film. Here, the adhesive layer may be formed of a UV-curable adhesive.

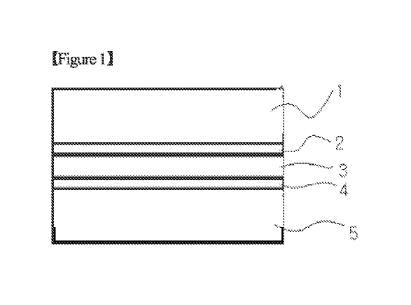

FIG. 1 shows a luminance enhancement film including a multilayer thin film 3, adhesive layers 2 and 4 formed on both sides of the multilayer thin film 3, and light diffusion films 1 and 5 respectively formed on the adhesive layers 2 and 4. However, the structure of the luminance enhancement film of the present invention is not limited thereto.

The luminance enhancement film obtained by attaching the light diffusing film to the multilayer film has often been problematic because its luminance deteriorates depending on temperature conditions, usage period or the like. One of the reasons for this may be that the light diffusion thin film is separated from the multilayer thin film. Of course, such a phenomenon may also occur even when the light diffusion layer is formed by applying a light diffusion composition onto the multilayer thin film.

In order to solve the above problem, when the surface hydrophilicity of the multilayer thin film is improved to meet the-above condition of luminance reduction rates, sufficient interlayer adhesion can be provided between the multilayer thin film and the light diffusion film by directly applying a light diffusion composition onto the multilayer thin film or by laminating the light diffusion film and the multilayer thin film using an adhesive, thus meeting the-above condition of luminance reduction rates.

For this reason, the surface contact angle of the multilayer thin film may be 50˜85°, and preferably 70˜85°.

The surface hydrophilicity of the multilayer thin film can be improved by changing its surface characteristics using chemical treatment and physical treatment. In the case of physical treatment, the surface hydrophilicity thereof can be improved while the multilayer thin film is extruded, but the surface characteristics thereof change with the passage of time, and it is difficult to obtain satisfactory surface hydrophilicity. In the case of chemical treatment, there is a method of coating the multilayer thin film with a primer after extruding the multilayer thin film. However, this method is disadvantageous in that the refractive index of the primer layer cannot be easily matched with those of the resin layers of the multilayer thin film, thus deteriorating luminance. Therefore, in the present invention, it is preferred that the multilayer thin film be formed using a polymer resin which constitutes a first thin film and/or a second thin film and which did not undergo solid-phase polymerization. When the multilayer thin film is formed of a polymer resin which did not undergo solid-phase polymerization, the surface hydrophilicity of the multilayer thin film can be increased. The reason for this is understood that a hydroxy group exists at the terminal of the polymer resin. In this way, when the surface hydrophilicity of the multilayer thin film is increased, the adhesivity between the multilayer thin film and the adhesive layer, the adhesivity between the adhesive layer and the light diffusion film and the adhesivity between the multilayer thin film and the light diffusion layer can be improved, thus satisfying the above-mentioned condition of the luminance reduction rate of the luminance enhancement film.

A luminance enhancement film according to another embodiment of the present invention includes a multilayer thin film including a first thin film and a second thin film, a first skin layer formed on one side of the multilayer thin film, and a light diffusion layer formed on the first skin layer. The luminance enhancement film may further include a second skin layer formed on the other side of the multilayer thin film, and may also further include an anti-blocking layer formed on the second skin layer. Here, the second skin layer is the same as or similar to the first skin layer except for its position, and thus a detailed description of the second skin layer will be omitted.

The luminance enhancement film having such a structure can diffuse light while increasing luminance. In this case, the luminance enhancement film may be manufactured by directly forming the light diffusion layer on the skin layer. This method of manufacturing the luminance enhancement film is simple compared to another method of providing a light diffusion function to the luminance enhancement film, for example, a method of manufacturing the luminance enhancement film by attaching a general light diffusion film to a member provided with the multilayer thin film because a lamination process is not required. Further, this method is advantageous in that the adhesivity between the layers of the luminance enhancement film can be ensured, and, consequently, it is possible to prevent the luminance reduction rate from being increased during long-term use and with the passage of time.

The first skin layer blocks factors which have negative effects from being introduced into the multilayer thin film, thus improving the durability, thermal stability, chemical resistance and the like of the luminance enhancement film.

In order to improve the adhesivity between the first skin layer and the light diffusion layer formed on the first skin layer, the first skin layer may include a polymer resin having excellent adhesivity to the binder resin and/or light diffusion particles included in the light diffusion layer. For example, the polymer resin included in the first skin layer may have a specific viscosity of 0.5 dL/g or less. Further, the polymer resin may be a resin which did not undergo solid-phase polymerization. More specifically, the polymer resin included in the first skin layer may include at least one of the polymer resin of the first thin film and the polymer resin of the second thin film. In this case, there is an advantage in that the first skin layer and the multilayer thin film can be formed simultaneously or sequentially.

When the skin layer is formed of a polymer resin which did not undergo solid-phase polymerization, the hydrophilicity of the skin layer can be increased. The reason for this is understood to be that a hydroxy group exists at the terminal of the polymer resin. In this way, when the hydrophilicity of the skin layer is increased, the adhesivity between the skin layer and the multilayer thin film and the adhesivity between the skin layer and the light diffusion layer can be improved. Here, the hydrophilicity of the skin layer may be improved to such a degree that the contact angle of the surface of the skin layer is 50˜85°, and preferably 70˜85°.

The specific viscosity of the polymer resin of the first skin layer may be 0.5 dL/g or less. When the specific viscosity thereof is greater than 0.5 dL/g, the stretch ratio of the first skin layer is limited, and it is difficult to obtain a multilayer thin film having a high stretch rate at low temperature.

The thickness of the first skin layer may be equal to or smaller than that of the multilayer thin film. When the thickness of the first skin layer is greater than that of the multilayer thin film, it is difficult to make the luminance enhancement film thin. However, considering various uses, the thickness of the first skin layer may be increased to obtain a luminance enhancement film with the optimum thickness. When the thickness of the first skin layer is increased, there may be an advantage in terms of ensuring the reliability to the external environment.

According to the above embodiments of the present invention, the multilayer thin film may be an alternate multilayer thin film, that is, a laminate in which repetitive units each including the first thin film and the second thin film are alternately stacked, but is not limited thereto. For example, each of the repetitive units may further include at least one thin film different from the first and second thin films at a predetermined position therein. Further, the repetitive units each including the first thin film and the second thin film and at least one repetitive unit different from each of the repetitive units may be stacked regularly or irregularly.

The first thin film may be an optically anisotropic thin film, and the second thin film may be an optically isotropic thin film. In the above and following descriptions, the term “optical isotropy” means that the refractive indexes along all axes in the plane of a thin film are substantially equal to each other, and the term “optical anisotropy” means that the refractive indexes along all axes in the plane of a thin film are substantially different from each other.

Examples of the polymer resin that can form the first thin film which is an optically anisotropic thin film may include a resin having an ethylene naphthalate repetitive unit content of 80 mol % or more, a resin having an ethylene naphthalate repetitive unit content of 85 mol % or more, a resin having an ethylene naphthalate repetitive unit content of 90 mol % or more, a resin having an ethylene naphthalate repetitive unit content of 95 mol % or more, and a resin having an ethylene naphthalate repetitive unit content of 98 mol % or more. Further, the first thin film may include a resin having an ethylene naphthalate repetitive unit content of 100 mol %, and may also include two or more kinds of the resins.

The first thin film may include a resin having an ethylene naphthalate repetitive unit content of 80˜100 mol % and a resin having an ethylene naphthalate repetitive unit content of 0˜20 mol %. Preferably, the first thin film may include a resin having an ethylene naphthalate repetitive unit content of 90˜100 mol % and a resin having an ethylene naphthalate repetitive unit content of 0˜10 mol %.

The resin of the first thin film may be prepared by the polycondensation of dimethylcarboxylic naphthalate (NDC) and ethylene glycol (EG) or the polycondensation of dimethylcarboxylic naphthalate (NDC), ethylene glycol (EG) and terephthalic acid (TPA).

The second thin film, which is an optically isotropic thin film, may include a resin having an ethylene naphthalate repetitive unit content of 10˜60 mol %. Preferably, the second thin film may include a resin having an ethylene naphthalate repetitive unit content of 10˜60 mol % and a resin having an ethylene naphthalate repetitive unit content of 40˜90 mol %. More preferably, the first thin film may include a resin having an ethylene naphthalate repetitive unit content of 40˜60 mol % and a resin having an ethylene naphthalate repetitive unit content of 40˜60 mol %.

The resin of the second thin film may be prepared by the polycondensation of dimethylcarboxylic naphthalate (NDC), ethylene glycol (EG) and terephthalic acid (TPA).

At least one of the first thin film and the second thin film, preferably, all of the first thin film and the second thin film may include a polymer resin having a specific viscosity of 0.5 dL/g or less. When the specific viscosity of the polymer resin is more than 0.5 dL/g, rheological defects in the polymer fluid may occur during a stretching process. Further, the stretch ratio of the thin film is limited, and it is difficult to form a multilayer thin film having a high stretch rate at low temperature. For this reason, at least one of the polymer resins constituting the first thin film and the second thin film may be a polymer resin which did not undergo solid-phase polymerization.

In the case where the first thin film and the second thin film include a first polymer resin and a second polymer resin, respectively, the difference in glass transition temperature between the first polymer resin and the second polymer resin may be 30° C. or less. When the difference in glass transition temperature therebetween is more than 30° C., the difference in melt viscosity between coextruded resins becomes great, so that it is difficult to uniformly adjust the thickness of each polymer resin layer and to form a polymer resin layer.

Owing to the first and second thin films, the above-mentioned luminance enhancement film of the present invention includes orthogonally-intersecting first and second axes in the plane thereof. The luminance enhancement film can reflect the incident light polarized along the first axis, and can transmit the incident light polarized along the second axis. The incident light may be ultraviolet light, visible light or infrared light or the like. For example, when the luminance enhancement film is employed in displays, the incident light may be visible light.

In order to allow the luminance enhancement film to have selective transmissivity and reflectivity to the light in a specific wavelength band, each of the first and second thin films may have optical thickness defined by the product of refractive index and thickness, and the optical thickness may be constant or variable. For example, each of the first and second thin films may have an optical thickness of 0.01˜1.50 μm, preferably 0.02˜1.00 μm, and more preferably 0.03˜0.90 μm.

The difference in refractive index between the first thin film and the second thin film according to the first axis may be 0.05 or more. The difference in refractive index between the first thin film and the second thin film according to the second axis may be 0.03 or less. Meanwhile, the luminance enhancement film includes a normal axis vertical to the plane thereof, that is, a third axis, and the difference in refractive index between the first thin film and the second thin film according to the third axis may be 0.03 or less. Here, when the difference in refractive index between the first thin film and the second thin film according to the first axis is less than 0.05, the amount of light reflected from the interface between the first thin film and the second thin film decreases, and thus the effect of increasing the luminance of the luminance enhancement film is small. When the difference in refractive index between the first thin film and the second thin film according to the second axis is more than 0.03 or when the difference in refractive index between the first thin film and the second thin film according to the third axis is more than 0.03, the amount of the light reflected from an adjacent plane increases, and thus the increase of the luminance of the luminance enhancement film can be prevented. The difference of refractive index according to each of the first to third axes can be overcome by a material having birefringence caused by stretching, a material having no birefringence or a material having low birefringence. Here, the first axis may be a stretching axis.

As such, in the luminance enhancement film including the first thin film and the second thin film adjacent to the first thin film, the desired reliability to the external environment can be realized by adjusting the composition of the first thin film, the difference in refractive index between the first thin film and the second thin film, the difference in glass transition temperature therebetween, and the like.

According to the above embodiments of the present invention, the light diffusion layer may include a binder resin and light diffusion particles.

The binder resin is not particularly limited as long as it can improve the adhesivity between the light diffusion layer and adjacent layers. The kind of the binder resin does not greatly influence the adhesivity therebetween because the hydrophilicity of the multilayer thin film or the skin layer was improved as described above. Examples of the binder resin may include thermosetting or UV-curable resins, such as polyvinyl resin, acrylic resin, polyester resin, styrene resin, alkyd resin, amino resin, polyurethane resin, epoxy resin, etc. They may be used independently or as a combination thereof.

When urethane acrylate is used as the binder resin, it is inferred that the adhesivity between the first skin layer and the light diffusion layer can be improved more because the condensation reaction of a hydroxy group remaining at the terminal of the polymer resin of the hydrophilicity-improved multilayer thin film or skin layer with an isocyanate group of the binder resin may take place.

The light diffusion particles included in the light diffusion layer may be organic or inorganic particles. Examples of the inorganic particles may include silica, zirconia, calcium carbonate, barium sulfate, titanium oxide, and the like. Examples of the organic particles may include homopolymers or copolymers obtained from monomers such as styrene, melamine formaldehyde, benzoguanamine formaldehyde, benzoguanamine melamine formaldehyde, propylene, ethylene, silicon, urethane, methyl(meth)acylate and the like. They may have a monodisperse or multidiperse form, but are not limited thereto.

The amount of the light diffusion particles may be 20˜200 parts by weight based on 100 parts by weight of the binder resin. When the amount of the light diffusion particles is less than 20 parts by weight, there is a problem in that the diffusibility of the luminance enhancement film becomes low, and thus the luminance of the luminance enhancement film deteriorates at a vertical viewing angle of 50˜60° when the front is set at 0°. Further, when the amount thereof is more than 200 parts by weight, there is a problem in that the turbidity of the luminance enhancement film increases, and the light diffusion particles are separated by external shock, thereby completely deteriorating the luminance of the luminance enhancement film.

Meanwhile, when the light diffusion layer includes light diffusing particles having different particle sizes from each other, the luminance enhancement film is able to exhibit the proper hiding power and improved luminance. Therefore, the light diffusion layer may include at least one of first light diffusion particles having an average particle size of 1˜20 μm and second light diffusion particles having an average particle size of 20˜40 μm.

Further, when the light diffusion layer includes light diffusing particles having different refractive indexes from each other as well as having different particle sizes from each other, the hiding power and luminance of the luminance enhancement film can be more improved. For example, the light diffusion layer may include first light diffusion particles having an average particle size of 1˜20 μm and a refractive index of n1 and second light diffusion particles having an average particle size of 20˜40 μm and a refractive index of n2. Here, when n1 and n2 are different from each other, the difference in refractive index therebetween satisfies |n1−n2|>0.02. When the difference in refractive index therebetween does not satisfy this range, the diffusibility of the luminance enhancement film is somewhat deteriorated, and the hiding power thereof is reduced, so that moiré is not hidden in multilayer extrusion, and thereby is comparatively inferior.

Preferably, the light diffusion layer may include first light diffusion particles and second light diffusion particles in a content ratio of 10:90˜90:10. When the content ratio deviates from this range, the gap between large particles is filled with small particles, so that the turbidity of the luminance enhancement film increases and the transmissivity thereof decreases, thereby deteriorating the luminance thereof.

The thickness ratio of the light diffusion layer and the multilayer thin film may be 0.5 or less. When the thickness ratio thereof does not satisfy this range, the luminance enhancement film can obtain predetermined hiding power, but the luminance thereof may drop.

The anti-blocking layer prevents the luminance enhancement film from adhering closely to another member disposed on one side thereof, and minimizes friction, thereby preventing the quality of moiré or the like from being deteriorated. Moreover, the anti-blocking layer can prevent static electricity.

The anti-blocking layer may include a binder resin and 0.1˜100 parts by weight of beads based on 100 parts by weight of the binder resin. The binder resin may be selected from the binder resins used in the light diffusion layer. The beads may be made of any material constituting the light diffusion particles of the light diffusion layer.

The luminance enhancement film may be manufactured by extrusion and stretching, deposition, coating or the like. Preferably, the luminance enhancement film may be manufactured by multilayer-extruding a first thin film and a second thin film and then stretching the multilayer-extruded thin film. Hereinafter, the process of manufacturing a luminance enhancement film using the multilayer-extrusion and stretching will be schematically described. First, dimethylcarboxylic naphthalate (NDC), ethylene glycol (EG) and terephthalic acid (TPA) are put into a polymerization reactor in a predetermined ratio, and are then polycondensed to prepare a first polymer resin and a second polymer resin. Preferably, the first polymer resin and/or the second polymer resin are not solid-phase-polymerized, and are not completely polymerized. The first and second polymer resins are dried to remove moisture therefrom, and are then coextruded by an extruder provided with a multilayer feed block to form a multilayer extruded film in which the first polymer resin and the second polymer resin are alternately stacked. The multilayer extruded film is continuously monoaxially-stretched at predetermined temperature, stretch ratio and stretching rate to manufacture a luminance enhancement film. In this way, the multilayer thin film obtained from the polymer resin which did not undergo solid-phase polymerization has high surface hydrophilicity. Thereafter, if necessary, a UV-curable adhesive may be applied onto both sides of the stretched multilayer thin film, and then the stretched multilayer thin film coated with the UV-curable adhesive may be laminated with a polycarbonate (PC) film having diffusibility or a polyester film including a diffusion layer and then may be passed through a UV-curing machine. Even when such a lamination method is used, luminance stability depending on temperature change and long-term use can be realized. If the luminance enhancement film includes a skin layer, the luminance enhancement film can be manufactured by coextruding the multilayer thin film provided with a skin layer and then coating the skin layer of the multilayer thin film with a solution including a binder resin and light diffusion particles.

The relative luminance rate measured at an angle of 50° from the normal line of the plane of the luminance enhancement film may be at least 180%, preferably at least 200%, and preferably 230%. Here, the relative luminance rate is defined as the ratio of the luminance measured when the luminance enhancement film is used to the luminance measured when the luminance enhancement film is not used at a predetermined angle. The relative luminance rate means the rate of change of luminance depending on whether or not the luminance enhancement film is used, and the method of measuring the luminance will be described in detail in the following Examples.

The luminance enhancement film can be applied to a backlight unit of a liquid crystal display. When the luminance enhancement film is used, a high-luminance backlight unit having a luminance increase rate of 1.0 or more can be realized. Here, the “luminance increase rate” is defined as the ratio of the luminance measured when the luminance enhancement film is used to the luminance measured when the luminance enhancement film is not used. The method of measuring the luminance will be described in detail in the following Examples.

### MODE FOR INVENTION

Hereinafter, the present invention will be described in detail with reference to the following Examples. These Examples are set forth to illustrate the present invention, and the scope of the present invention is not limited thereto.

### Example 1

Dimethylcarboxylic naphthalate (NDC), ethylene glycol (EG) and terephthalic acid (TPA) were put into a polymerization reactor, and were then polycondensed to prepare a first polymer resin having an ethylene naphthalate repetitive unit content of 100 mol %. Further, dimethylcarboxylic naphthalate (NDC), ethylene glycol (EG) and terephthalic acid (TPA) were put into a polymerization reactor, and were then polycondensed to prepare a second polymer resin having an ethylene naphthalate repetitive unit content of 40 mol % and an ethylene terephthalate repetitive unit content of 60 mol %. Both the first polymer resin and the second polymer resin were completely polymerized while not undergoing solid-phase polymerization. The first polymer resin was dried at 100° C. for 24 hours to remove moisture therefrom, and the second polymer resin was dried at 70° C. for 48 hours to remove moisture therefrom. Subsequently, the first and second polymer resins were respectively coextruded by an extruder provided with a 256-fold multilayer feed block at an extrusion rate of 30 kg/hr to form a multilayer extruded film (1024 layers). Subsequently, the multilayer extrude film was monoaxially stretched at a stretch ratio of 5 at 130° C. Then, the monoaxially stretched multilayer film was coated on both sided thereof with an acrylic UV-curable adhesive, laminated with a diffusion film (LD102, manufactured by Kolon Corp.) and then irradiated with UV at a radiation intensity of 500 mJ/cm² to manufacture a luminance enhancement film.

### Examples 2 and 3

Luminance enhancement films were manufactured in the same manner as in Example 1, except that, as given Table 1 below, first and second polymer resin having ethylene naphthalate repetitive unit contents and ethylene terephthalate repetitive unit contents different from each other, which were obtained by changing the amounts of dimethylcarboxylic naphthalate (NDC), ethylene glycol (EG) and terephthalic acid (TPA), were applied. As in Example 1, the first and second polymer resins were completely polymerized while not undergoing solid-phase polymerization.

### Examples 4 to 6

Each of the multilayer extruded films formed using the respective first and second polymer resins obtain from Examples 1 to 3 was stretched in the same manner as in Example 1. Subsequently, each of the stretched multilayer films was provided on one side thereof with a diffusion layer including 135 parts by weight of polymethylmethacrylate particles having a particle size of 10 μm based on 100 parts by weight of a urethane acrylate binder, and was provided on the other side thereof with an anti-blocking layer including 15 parts by weight of polymethylmethacrylate particles having a particle size of 5 μm based on 100 parts by weight of a urethane acrylate binder such that the turbidity of the stretched multilayer film is 5% in order to prevent the stretched multilayer film from blocking a lower optical member, thereby finally manufacturing luminance enhancement films.

### Comparative Example 1

Dimethylcarboxylic naphthalate (NDC), ethylene glycol (EG) and terephthalic acid (TPA) were put into a polymerization reactor, and were then polycondensed to prepare a first polymer resin having an ethylene naphthalate repetitive unit content of 100 mol %. Further, dimethylcarboxylic naphthalate (NDC), ethylene glycol (EG) and terephthalic acid (TPA) were put into a polymerization reactor, and were then polycondensed to prepare a second polymer resin having an ethylene naphthalate repetitive unit content of 40 mol % and an ethylene terephthalate repetitive unit content of 60 mol %. Both the first polymer resin and the second polymer resin were completely polymerized while undergoing solid-phase polymerization. The first polymer resin was dried at 100° C. for 24 hours to remove moisture therefrom, and the second polymer resin was dried at 70° C. for 48 hours to remove moisture therefrom. Subsequently, the first and second polymer resins were respectively coextruded by an extruder provided with a 256-fold multilayer feed block at an extrusion rate of 30 kg/hr to form a multilayer extruded film (1024 layers). Subsequently, the multilayer extruded film was monoaxially stretched at a stretch ratio of 5 at 130° C. Then, both sides of the monoaxially stretched multilayer film were coated with an acrylic UV-curable adhesive, laminated with a diffusion film (LD102, manufactured by Kolon Corp.) and then irradiated with UV at a radiation intensity of 500 mJ/cm² to manufacture a luminance enhancement film.

### Comparative Examples 2 and 3

Luminance enhancement films were manufactured in the same manner as in Comparative Example 1, except that, as given Table 1 below, first and second polymer resins having ethylene naphthalate repetitive unit contents and ethylene terephthalate repetitive unit contents different from each other, which were obtained by changing the amounts of dimethylcarboxylic naphthalate (NDC), ethylene glycol (EG) and terephthalic acid (TPA), were applied. As in Comparative Example 1, the first and second polymer resins were completely polymerized while undergoing solid-phase polymerization.

### Comparative Examples 4 to 6

Multilayer extruded films were formed using the respective first and second polymer resins obtain from Comparative Examples 1 to 3, stretched in the same manner as in Comparative Example 1, and then directly coated with the diffusion layers of Examples 4 to 6 to manufacture luminance enhancement films.

The physical properties of the luminance enhancement films manufactured in Examples 1 to 6 and Comparative Examples 1 to 6 depending on environmental change were measured as follows.

(1) Luminance Reduction Rate

A 22 inch backlight unit was combined with a diffusion film (XC210, manufactured by Kolon Corp.) and a prism film (LC217, manufactured by Kolon Corp.) as optical films, and then a luminance enhancement film meeting each condition or a general luminance enhancement film was stacked thereon. Subsequently, a 22 inch LCD panel was put on the backlight unit, a voltage of 12V was applied thereto, and then luminances were measured using a luminance meter (BM-7, manufactured by TOPCON Corp. in Japan). Based on the measured luminances, the luminance reduction rates thereof were calculated for each condition.

(2) Glass Transition Temperature

First and second polymer resin pellets were quantitatively weighed in an amount of 4 mg, respectively, to fabricate samples. Subsequently, the glass transition temperatures of the first and second polymer resins were respectively measured using a differential scanning calorimeter (DSC, manufactured by Perkin Elmer Corp.) while heating the samples to 30˜300° C. Based on the measured glass transition temperatures, the difference in glass transition temperature between the first and second polymer resins was calculated.

(3) Refractive Index

The first polymer resin and the second polymer resin are each independently formed into sheets. Each of the sheets was monoaxially stretched at a stretch ratio of 6 at 130° C., was cut to a size of 50 mm×50 mm, was mounted on a prism coupler (SPA-3DR, manufactured by Sairon Technology Corp.), and was then irradiated with a laser of 632.8 nm to measure the refractive indexes of the first and second polymer resin sheets. Based on the measured refractive indexes, the difference in refractive index between the first and second polymer resin sheets was calculated.

(4) Evaluation of Adhesivity

In the case where a luminance enhancement film was obtained by attaching a stretched multilayer film to a diffusion film using a UV-curable resin (adhesive layer), the luminance enhancement film was cut to a size of 25 mm×150 mm, immersed in boiling water of 100° C., and then dried. Subsequently, the load values required when each of the diffusion film and the multilayer film of the luminance enhancement film was mounted on a zig and then peeled at an angle of 180 at a peeling rate of 300 mm/min were measured.

Further, in the case where a luminance enhancement film was obtained by directly applying a diffusion layer onto a stretched multilayer film, the adhesivity of the luminance enhancement film was evaluated by a cross cut test. That is, in the cross cut test, in order to evaluate the adhesivity of the luminance enhancement film, the number of the lattices remaining on the surface of the luminance enhancement film was measured after scratching the luminance enhancement film to form 100 lattices or more, attaching the scratched film to an adhesive tape (manufactured by 3M Corp.) and then detaching it from the adhesive tape.

(5) Contact Angle of Surface of Multilayer Thin Film

A sample having a size of 50 mm×50 mm was fixed on a plate, a drop of DI water was dropped onto the sample, and then the contact angle of the surface of the sample was measured using a drop shape analyzer (DSA100). The contact angles thereof were measured 10 times or more, and the average contact angle was calculated based on the measured contact angles. The average contact angle was obtained by measuring contact angles at 9 points per sample.

TABLE 1

| | First thin film | | Second thin film | |
|---|---|---|---|---|
| | Content of | Content of | Content of | Content of |
| | ethylene | ethylene | ethylene | ethylene |
| | terephthalate | terephthalate | terephthalate | terephthalate |
| Exp. 1 | 100 mol % | 0 mol % | 40 mol % | 60 mol % |
| Exp. 2 | 90 mol % | 10 mol % | 60 mol % | 40 mol % |
| Exp. 3 | 80 mol % | 20 mol % | 50 mol % | 50 mol % |
| Exp. 4 | 100 mol % | 0 mol % | 40 mol % | 60 mol % |
| Exp. 5 | 90 mol % | 10 mol % | 60 mol % | 40 mol % |
| Exp. 6 | 80 mol % | 20 mol % | 50 mol % | 50 mol % |
| Comp. | 100 mol % | 0 mol % | 40 mol % | 60 mol % |
| Exp. 1 | | | | |
| Comp. | 90 mol % | 10 mol % | 60 mol % | 40 mol % |
| Exp. 2 | | | | |
| Comp. | 80 mol % | 20 mol % | 50 mol % | 50 mol % |
| Exp. 3 | | | | |
| Comp. | 100 mol % | 0 mol % | 40 mol % | 60 mol % |
| Exp. 4 | | | | |
| Comp. | 90 mol % | 10 mol % | 60 mol % | 40 mol % |
| Exp. 5 | | | | |
| Comp. | 80 mol % | 20 mol % | 50 mol % | 50 mol % |
| Exp. 6 | | | | |

TABLE 2

| | | | | | Difference in | |
|---|---|---|---|---|---|---|
| | Luminance reduction rate | | | | glass transition | |
| | | 60° C., | | 70° C./ | temperature | |
| | 50° C., | 95% RH, | −20° C., | 60 min~20° C./ | between | Refractive |
| | 1000 | 1000 | 1000 | 60 min | first and second | index |
| | hours | hours | hours | 100 cycle | polymer resins | difference |
| Exp. 1 | 5% | 7% | 5% | 5% | 20° C. | 0.01 |
| Exp. 2 | 8% | 10% | 7% | 10% | 25° C. | 0.03 |
| Exp. 3 | 9% | 10% | 7% | 10% | 10° C. | 0.03 |
| Exp. 4 | 6% | 8% | 5% | 6% | 20° C. | 0.01 |
| Exp. 5 | 8% | 10% | 6% | 9% | 25° C. | 0.03 |
| Exp. 6 | 7% | 10% | 7% | 10% | 10° C. | 0.03 |
| Comp. | 15% | 13% | 15% | 15% | 20° C. | 0.01 |
| Exp. 1 | | | | | | |
| Comp. | 15% | 15% | 15% | 15% | 25° C. | 0.03 |
| Exp. 2 | | | | | | |
| Comp. | 15% | 18% | 15% | 17% | 10° C. | 0.03 |
| Exp. 3 | | | | | | |
| Comp. | 16% | 15% | 18% | 19% | 20° C. | 0.01 |
| Exp. 4 | | | | | | |
| Comp. | 16% | 18% | 18% | 18% | 25° C. | 0.03 |
| Exp. 5 | | | | | | |
| Comp. | 15% | 16% | 19% | 19% | 10° C. | 0.03 |
| Exp. 6 | | | | | | |

TABLE 3

| | | Surface contact |
|---|---|---|
| | | angle of multilayer |
| | Adhesivity | thin film (°) |
| Exp. 1 | 1.5 kg/25 mm | 70 |
| Exp. 2 | 1.3 kg/25 mm | 71 |
| Exp. 3 | 1.4 kg/25 mm | 72 |
| Exp. 4 | 100/100 | 70 |
| Exp. 5 | 100/100 | 72 |
| Exp. 6 | 100/100 | 73 |
| Comp. Exp. 1 | 0.5 kg/25 mm | 90 |
| Comp. Exp. 2 | 0.45 kg/25 mm | 93 |
| Comp. Exp. 3 | 0.45 kg/25 mm | 93 |
| Comp. Exp. 4 | 50/100 | 90 |
| Comp. Exp. 5 | 45/100 | 93 |
| Comp. Exp. 6 | 45/100 | 93 |

As the result of evaluating the physical properties, it can be seen from Tables 2 and 3 above that the luminance reduction rate characteristics of the luminance enhancement films of Examples 1 to 6 are better than those of the luminance enhancement films of Comparative Examples 1 to 6, and that these luminance reduction rate characteristics are closely connected with the contact angle of the surface of the multilayer thin film and the interlayer adhesion. In other words, it can be seen that, as the hydrophilicity of the multilayer thin film is improved, the adhesivity of the luminance enhancement film is also improved even when the luminance enhancement film was manufactured by directly applying a light diffusion composition onto the multilayer thin film or attaching a light diffusion film to the multilayer thin film, thereby decreasing the luminance reduction rate of the luminance enhancement film.

### Example 7

Polyethylene naphthalate having a specific viscosity of 0.48 dL/g as a first polymer resin, and an ethylene naphthalte-ethylene terephthalate copolymer including 40 mol % of ethylene naphthalate as a second polymer resin (specific viscosity: 0.48 dL/g) were respectively coextruded by an extruder provided with a 256-fold multilayer feed block at an extrusion rate of 30 kg/hr to form a multilayer extruded film (1024 layers) in which the first polymer resin and the second polymer resin are alternately stacked. Subsequently, polyethylene naphthalate having a specific viscosity of 0.48 dL/g as a polymer resin for forming a skin layer was extruded by an extruder provided with a three-layer feed block at an extrusion rate of 30 kg/hr to finally form a multilayer thin film having a skin layer. All of the first polymer resin, the second polymer resin and the polymer resin for forming a skin layer were formed while not undergoing solid-phase polymerization. The multilayer thin film having the skin layer was stretched at a stretch ratio of 5 at 125° C. Then, the stretched multilayer thin film was provided on one side thereof with a diffusion layer including 135 parts by weight of polymethylmethacrylate particles having a particle size of 10 μm based on 100 parts by weight of a urethane acrylate binder resin, and was provided on the other side thereof with an anti-blocking layer including 15 parts by weight of polymethylmethacrylate particles having a particle size of 5 μm based on 100 parts by weight of a urethane acrylate binder resin such that the turbidity of the stretched multilayer film is 5% in order to prevent the stretched multilayer film from blocking a lower optical member, thereby finally manufacturing a luminance enhancement film.

### Example 8

A luminance enhancement film was manufactured in the same manner as in Example 7, except that polyethylene naphthalate having a specific viscosity of 0.5 dL/g used as a first polymer resin, and polyethylene naphthalate having a specific viscosity of 0.5 dL/g was used as a polymer resin for forming a skin layer.

### Examples 9 to 11

Luminance enhancement films were manufactured in the same manner as in Example 7, except that, as given in Table 1 above, the amounts of polymethylmethacrylate particles included in the diffusion layer were changed into 100 parts by weight, 150 parts by weight and 200 parts by weight based on 100 parts by weight of a urethane acrylate binder resin.

### Example 12

A luminance enhancement film was manufactured in the same manner as in Example 7, except that, as light diffusion particles for forming a light diffusion layer, first light diffusion particles having an average particle size of 1˜20 μm and a refractive index of 1.45 and second light diffusion particles having an average particle size of 20˜40 μm and a refractive index of 1.50 were respectively included in an amount of 100 parts by weight based on 100 parts by weight of a urethane acrylate binder resin.

### Reference Example 1

A luminance enhancement film was manufactured in the same manner as in Example 7, except that a multilayer thin film and a skin layer was formed using polyethylene naphthalate having a specific viscosity of 0.6 dL/g (solid-phase polymerization was performed) as a first polymer resin.

### Reference Examples 2 and 3

Luminance enhancement films were manufactured in the same manner as in Example 7, except that, as given in Table 1 above, the amounts of polymethylmethacrylate particles included in the diffusion layer were changed into 20 parts by weight and 250 parts by weight based on 100 parts by weight of a urethane acrylate binder resin.

### Comparative Example 7

Polyethylene naphthalate having a specific viscosity of 0.6 dL/g as a first polymer resin, and an ethylene naphthalate-ethylene terephthalate copolymer including 40 mol % of ethylene naphthalate as a second polymer resin (specific viscosity: 0.6 dL/g) were respectively coextruded by an extruder provided with a 256-fold multilayer feed block at an extrusion rate of 30 kg/hr to form a multilayer extruded film (1024 layers) in which the first polymer resin and the second polymer resin are alternately stacked. Subsequently, the multilayer extruded film was monoaxially stretched at a stretch ratio of 5 at 130° C. Then, both sides of the monoaxially stretched multilayer film were coated with an acrylic UV-curable adhesive, laminated with a diffusion film (LD102, manufactured by Kolon Corp.) and then irradiated with UV at a radiation intensity of 500 mJ/cm² to manufacture a luminance enhancement film.

The luminance increase rates and relative luminance rates of Examples 7 to 12 and Comparative Example 1 are given in Table 4 below, and the luminance reduction rates thereof are given in Table 5 below.

(1) Luminance

A 22 inch backlight unit was combined with a diffusion film (XC210, manufactured by Kolon Corp.) and a prism film (LC217, manufactured by Kolon Corp.) as optical films, and then a luminance enhancement film was stacked thereon. Subsequently, a 22 inch LCD panel was put on the backlight unit, a voltage of 12V was applied thereto, and then luminances were measured using a luminance meter (BM-7, manufactured by TOPCON Corp. in Japan).

(2) Luminance Increase Rate

The luminance increase rate was calculated by applying the measured luminances to the following Formula.

Luminance increase rate=(luminance when luminance enhancement film used)/(luminance when luminance enhancement film not used)

(3) Relative Luminance Rate

A 22 inch backlight unit was combined with a diffusion film (XC210, manufactured by Kolon Corp.) and a prism film (LC217, manufactured by Kolon Corp.) as optical films, and then a luminance enhancement film was stacked thereon. Subsequently, a 22 inch LCD panel was put on the backlight unit, a voltage of 12V was applied thereto, and then luminance values were measured at an angle of 50° from the normal line of the plane of the luminance enhancement film using a luminance meter (BM-7, manufactured by TOPCON Corp. in Japan). The relative luminance rate was converted using the measured luminance values.

(4) Evaluation of Adhesivity

In the case where a luminance enhancement film was obtained by attaching a stretched multilayer film to a diffusion film using a UV-curable resin (adhesive layer), the luminance enhancement film was cut to a size of 25 mm×150 mm, immersed in boiling water of 100° C., and then dried. Subsequently, the load values required when each of the diffusion film and the multilayer film of the luminance enhancement film was mounted on a zig and then peeled at an angle of 180 at a peeling rate of 300 mm/min were measured.

Further, in the case where a luminance enhancement film was obtained by directly applying a diffusion layer onto a stretched multilayer film, the adhesivity of the luminance enhancement film was evaluated by a cross cut test. That is, in the cross cut test, in order to evaluate the adhesivity of the luminance enhancement film, the number of lattices remaining on the surface of the luminance enhancement film was measured after scratching the luminance enhancement film to form 100 lattices or more, attaching adhesive tape (manufactured by 3M Corp.) to the scratched film and then detaching it from the adhesive tape.

(5) Hydrophilicity of Skin Layer (Measurement of Contact Angle)

A sample having a size of 50 mm×50 mm was fixed on a plate, a drop of DI water was dropped onto the sample, and then the contact angle of the surface of the sample was measured using a drop shape analyzer (DSA100). The contact angles thereof were measured 10 times or more, and the average contact angle was calculated based on the measured contact angles. The average contact angle was obtained by measuring contact angles at 9 points per sample.

However, in the case of Comparative Example 7, the hydrophilicity of the multilayer thin film was measured in the same manner as above.

(6) Luminance Reduction Rate

A 22 inch backlight unit was combined with a diffusion film (XC210, manufactured by Kolon Corp.) and a prism film (LC217, manufactured by Kolon Corp.) as optical films, and then a luminance enhancement film meeting each condition or a general luminance enhancement film was stacked thereon. Subsequently, a 22 inch LCD panel was put on the backlight unit, a voltage of 12V was applied thereto, and then luminances were measured using a luminance meter (BM-7, manufactured by TOPCON Corp. in Japan). Based on the measured luminances, the luminance reduction rates thereof were calculated for each condition.

TABLE 4

| | | Content of light | | | | |
|---|---|---|---|---|---|---|
| | Specific | diffusion | | | | |
| | viscosity of | particles in light | | Relative | | |
| | first polymer | diffusion layer | Luminance | luminance | Evaluation of | Hydrophilicity |
| | resin (dL/g) | binder resin | increase rate | rate (%) | adhesivity | of skin layer (°) |
| Exp. 7 | 0.48 | 135 parts by | 1.32 | 230 | 100/100 | 71 |
| | | weight | | | | |
| Exp. 8 | 0.50 | 135 parts by | 1.25 | 230 | 100/100 | 75 |
| | | weight | | | | |
| Exp. 9 | 0.48 | 100 parts by | 1.33 | 200 | 100/100 | 71 |
| | | weight | | | | |
| Exp. 10 | 0.48 | 150 parts by | 1.21 | 232 | 100/100 | 71 |
| | | weight | | | | |
| Exp. 11 | 0.48 | 200 parts by | 1.19 | 240 | 100/100 | 71 |
| | | weight | | | | |
| Exp. 12 | 0.48 | 200 parts by | 1.34 | 240 | 100/100 | 71 |
| | | weight | | | | |
| Ref. | 0.60 | 135 parts by | 0.82 | 150 | 45/100 | 90 |
| Exp. 1 | | weight | | | | |
| Ref. | 0.48 | 20 parts by | 0.98 | 120 | 100/100 | 71 |
| Exp. 2 | | weight | | | | |
| Ref. | 0.48 | 250 parts by | 0.88 | 140 | 100/100 | 71 |
| Exp. 3 | | weight | | | | |
| Comp. | 0.60 | — | 1.20 | 230 | 0.2 kg/25 mm | 90 |
| Exp. 7 | | | | | | |

As the result of evaluating the physical properties, it can be seen from Table 4 above that, owing to the skin layer, the luminance enhancement films of Examples 7 to 12 exhibit uniform luminance characteristics because the adhesivity between the multilayer thin film and the light diffusion layer is improved, and thus luminance increase rate is increased and the relative luminance rate is not decreased. Meanwhile, according to the results of Reference Examples 1 to 3, it can be ascertained that the relative luminance rate and luminance increase rate are influenced by whether or not the polymer resin used to form the multilayer thin film or the skin layer was prepared by solid-phase polymerization, and are influenced by the ratio of light diffusion particles in the light diffusion layer. Particularly, in the case where the light diffusion layer is directly formed on the skin layer, it can be seen that the adhesivity between the multilayer thin film and the light diffusion layer is improved when the polymer resin of the skin layer is not prepared by solid-phase polymerization.

Further, it can be seen from Table 5 below that the luminance reduction rate characteristics of the luminance enhancement films of Examples 7 to 12 are better than those of the luminance enhancement film of Comparative Example 7, and that these luminance reduction rate characteristics are closely connected with the contact angle of the surface of the skin layer and the interlayer adhesion. In other words, it can be seen that, as the hydrophilicity of the skin layer is improved, the adhesivity of the luminance enhancement film is also improved when the luminance enhancement film was manufactured by directly applying a light diffusion composition onto the multilayer thin film, thereby decreasing the luminance reduction rate of the luminance enhancement film.

TABLE 5

| | Luminance reduction rate | | | |
|---|---|---|---|---|
| | 50° C., | 60° C., | −20° C., | |
| | 1000 | 95% RH, | 1000 | 70° C./60 min~20° C./ |
| | hours | 1000 hours | hours | 60 min 100 cycle |
| Exp. 7 | 5% | 7% | 5% | 5% |
| Exp. 8 | 8% | 10% | 7% | 10% |
| Exp. 9 | 9% | 10% | 7% | 10% |
| Exp. 10 | 5% | 7% | 5% | 4% |
| Exp. 11 | 7% | 9% | 8% | 9% |
| Exp. 12 | 8% | 10% | 9% | 10% |
| Ref. Exp. 1 | 15% | 15% | 18% | 20% |
| Ref. Exp. 2 | 7% | 7% | 5% | 5% |
| Ref. Exp. 3 | 12% | 13% | 14% | 12% |
| Comp. | 15% | 13% | 15% | 15% |
| Exp. 7 | | | | |

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

1. A luminance enhancement film, comprising:
a multilayer thin film including at least one first thin film having optical isotropy and at least one second thin film having optical anisotropy; and
a light diffusion layer formed on at least one side of the multilayer thin film,
wherein a luminance reduction rate measured after subjecting the luminance enhancement film to a first environmental condition and a luminance reduction rate measured after subjecting the luminance enhancement film to a second environmental condition are each 10% or less,
wherein the first environmental condition is a condition that the luminance enhancement film is left for 1000 hours in a chamber having a temperature of 50° C., and the second environmental condition is a condition that the luminance enhancement film is left for 1000 hours in a chamber having a temperature of −20° C.

2. The luminance enhancement film of claim 1, wherein the luminance reduction rate measured after subjecting the luminance enhancement film to the first environmental condition and the luminance reduction rate measured after subjecting the luminance enhancement film to the second environmental condition are each 8% or less.

3. The luminance enhancement film of claim 1, wherein the luminance reduction rate measured after subjecting the luminance enhancement film to the first environmental condition and the luminance reduction rate measured after subjecting the luminance enhancement film to the second environmental condition are each 5% or less.

4. The luminance enhancement film of claim 1, wherein a luminance reduction rate measured after subjecting the luminance enhancement film to a third environmental condition and a luminance reduction rate measured after subjecting the luminance enhancement film to a fourth environmental condition are each 10% or less,
wherein the third environmental condition is a condition that the luminance enhancement film is left for 1000 hours in a chamber having a temperature of 60° C. a relative humidity (RH) of 95%, and the fourth environmental condition is a condition that the luminance enhancement film is left for 60 minutes in a chamber having a temperature of 70° C. and is then left for 60 minutes in a chamber having a temperature of −20° C., which are repeated 100 times.

5. The luminance enhancement film of claim 1, wherein the multilayer thin film has a surface contact angle of 50-85°.

6. The luminance enhancement film of claim 1, wherein the light diffusion layer comprises: 100 parts by weight of a binder resin; and 20-200 parts by weight of light diffusion particles.

7. The luminance enhancement film of claim 6, wherein the binder resin is a urethane acrylate resin.

8. The luminance enhancement film of claim 6, wherein the light diffusion particles comprise at least one of first light diffusion particles having an average particle size of 1-20 μm and second light diffusion particles having an average particle size of 20-40 μm.

9. The luminance enhancement film of claim 6, wherein the light diffusion particles comprise: first light diffusion particles having an average particle size of 1-20 μm and a refractive index of n1; and second light diffusion particles having an average particle size of 20-40 μm and a refractive index of n2, wherein the difference in refractive index satisfies |n1−n2|>0.02.

10. The luminance enhancement film of claim 7, wherein the light diffusion particles comprise first light diffusion particles and second light diffusion particles in a content ratio of 10:90-90:10.

11. The luminance enhancement film of claim 1, wherein the first thin film comprises a resin having an ethylene naphthalate repetitive unit content of 80 mol % or more.

12. The luminance enhancement film of claim 1, wherein the first thin film comprises a resin having an ethylene naphthalate repetitive unit content of 80-100 mol % and a resin having an ethylene naphthalate repetitive unit content of 0-20 mol %.

13. The luminance enhancement film of claim 1, wherein the second thin film comprises a resin having an ethylene naphthalate repetitive unit content of 10-60 mol %.

14. The luminance enhancement film of claim 1, wherein the second thin film comprises a resin having an ethylene naphthalate repetitive unit content of 10-60 mol % and a resin having an ethylene naphthalate repetitive unit content of 40-90 mol %.

15. The luminance enhancement film of claim 1, wherein the first thin film comprises a polymer resin having a specific viscosity of 0.5 dL/g or less.

16. The luminance enhancement film of claim 1, wherein the second thin film comprises a polymer resin having a specific viscosity of 0.5 dL/g or less.

17. The luminance enhancement film of claim 1, wherein the first thin film comprises a first polymer resin, the second thin film comprises a second polymer resin, and a difference in glass transition temperature between the first polymer resin and the second polymer resin is 30° C. or less.

18. The luminance enhancement film of claim 1, wherein the light diffusion layer is a light diffusion film including a base film and a light diffusion layer formed on the base film.

19. The luminance enhancement film of claim 18, further comprising an adhesive layer formed between the multilayer thin film and the light diffusion layer.

20. The luminance enhancement film of claim 1, wherein the multilayer thin film comprises a polymer resin, which did not undergo solid-phase polymerization, as a resin of the first thin film or the second thin film.

21. The luminance enhancement film of claim 1, comprising:
the multilayer thin film;
a light diffusion layer formed on one side of the multilayer thin film; and
an anti-blocking layer formed on the other side of the multilayer thin film.

22. The luminance enhancement film of claim 1, comprising:
the multilayer thin film;
a first skin layer formed on one side of the multilayer thin film; and
a light diffusion layer formed on the first skin layer.

23. The luminance enhancement film of claim 22, further comprising: a second skin layer formed on the other side of the multilayer thin film.

24. The luminance enhancement film of claim 23, further comprising: an anti-blocking layer formed on the second skin layer.

25. The luminance enhancement film of claim 22, wherein at least one of the first and second skin layers comprises a polymer resin having a specific viscosity of 0.5 dL/g or less.

26. The luminance enhancement film of claim 22, wherein the first skin layer and/or the second skin layer have a surface contact angle of 50˜85°.

27. The luminance enhancement film of claim 22, wherein the first skin layer and/or the second skin layer comprise a polymer resin which is not prepared by solid-phase polymerization.

28. The luminance enhancement film of claim 22, wherein at least one of the first and second skin layers has a thickness equal to or less than that of the multilayer thin film.

29. The luminance enhancement film of claim 1, wherein the luminance enhancement film comprises orthogonally-intersecting first and second axes in a plane thereof, wherein the luminance enhancement film reflects incident light polarized along the first axis, and transmits incident light polarized along the second axis.

30. The luminance enhancement film of claim 29, wherein a difference in refractive index between the first thin film and the second thin film according to the first axis is 0.05 or more.

31. The luminance enhancement film of claim 29, wherein a difference in refractive index between the first thin film and the second thin film according to the second axis is 0.03 or less.

32. The luminance enhancement film of claim 1, wherein the luminance enhancement film comprises a third axis perpendicular to a plane thereof, and a difference in refractive index between the first thin film and the second thin film according to the third axis is 0.03 or less.

33. The luminance enhancement film of claim 1, wherein a relative luminance rate measured at an angle of 50° from a normal line of a plane of the luminance enhancement film is at least 180%.

34. A backlight unit comprising the luminance enhancement film of claim 1.

35. The luminance enhancement film of claim 8, wherein the light diffusion particles comprise first light diffusion particles and second light diffusion particles in a content ratio of 10:90-90:10.

36. The luminance enhancement film of claim 23, wherein at least one of the first and second skin layers comprises a polymer resin having a specific viscosity of 0.5 dL/g or less.

37. The luminance enhancement film of claim 23, wherein the first skin layer and/or the second skin layer have a surface contact angle of 50-85°.

38. The luminance enhancement film of claim 23, wherein the first skin layer and/or the second skin layer comprise a polymer resin which is not prepared by solid-phase polymerization.

39. The luminance enhancement film of claim 23, wherein at least one of the first and second skin layers has a thickness equal to or less than that of the multilayer thin film.
